(19) United States
(12) Patent Application Publication
(10) Pub. No.: US 2013/0098920 A1
(43) Pub. Date: Apr. 25, 2013

(54) Nestable Cookware Assemblies

(71) Applicant: Meyer Intellectual Properties Ltd., Kowloon (HK)

(72) Inventor: Kwong Wah Lee, Hong Kong (CN)

(73) Assignee: Meyer Intellectual Properties Ltd., Kowloon (HK)

(21) Appl. No.: 13/656,538

(22) Filed: Oct. 19, 2012

Related U.S. Application Data
(60) Provisional application No. 61/550,799, filed on Oct. 24, 2011.

(51) Int. Cl. A47J 27/12; B65D 21/02

(52) U.S. Cl. 220/573.1; 220/23.83

(57) ABSTRACT

A nested cookware assembly deploys at least one cookware vessel having a pair of opposing handles, each handle disposed proximate to the rim of the cookware vessel and being adapted with a stair like upper surface to receive in a mating orientation a complementary stair like lower surface on the opposing handles of either a similar cookware vessel or a lid particularly fitted to the lid of a cookware vessel.

### CROSS REFERENCE TO RELATED APPLICATIONS

The present application claims the benefit of priority to the US Provisional Patent application of the same title that was filed on Oct. 24, 20122, having application Ser. No. 61/550,799, which is incorporated herein by reference.

### BACKGROUND OF INVENTION

The present invention relates to a cookware articles, and in particular to pot and pan sets wherein the pots nest within each other to form a compact assembly.

The nesting of vessels of different sizes is common for mixing bowls of different sizes as well as cooking sets. Such collections of sets of vessel are easier to store and ship as they require less space. However, there is inevitably some trade of required for size of the set and versatility of the cookware.

It is therefore a first object of the present invention to provide cookware vessels and mating lids in configuration that nest or stack very compactly, but yet provide greater versatility, with handles that are easy to grasp and store either with or separate from the cookware, that likewise do not take up excess space.

It is another object to product the above benefits in a stable nested arrangement with a reduced likelihood that the vessels and lids contact, scratch, abrade or mar each other.

### SUMMARY OF INVENTION

In the present invention, the first object is achieved by providing a cookware vessel comprising a container having a bottom surface and substantially upright surrounding sidewalls terminating in an upper rim, a pair of handles connected to the surrounding sidewalls proximal to the rim thereof, each handle being on an opposite side of the rim and having a gripping portion having; an upper surface and a lower surface on the opposite side of the upper surface, the upper surface of the gripping portion having adjacent outer and inner substantially planar horizontal portions and an at least partially vertical transition portion between the outer and inner planar portions, the lower surface of the gripping portion having at least one planar horizontal surface, a flange portion connected to the sidewalls of the cookware vessel, with the flange portion being connected to a gripping portion.

A second aspect of the invention is characterized by a covered cookware vessel comprising a container having a bottom surface and substantially upright surrounding sidewalls terminating in an upper rim, a lid adopted to cover at least an upper portion of the container within the upper rim thereof, the lid having an outer perimeter portion, each of the container and lid having a pair of handles, wherein the pair of handles of the container are coupled to the surrounding sidewalls proximal to the rim thereof, each handle being on an opposite side of the rim, and having a gripping portion with an upper surface and a lower surface on the opposite side of the upper surface, the upper surface of the gripping portion having adjacent outer and inner planar horizontal portions and an at least partially vertical transition portion between the outer and inner planar portions, the pair of handles of the lid are coupled to the outer perimeter portion thereof and having at least a lower surface comprising at least a substantially planar horizontal portion, wherein the substantially planar horizontal portions of the lid handles are adapted to nestingly engage within the inner planar horizontal portions of each gripping portion of the container handles so that when at least a portion of the lid engages the rim of the container the handles of the rim are supported by the gripping portion of the handles of the container.

A third aspect of the invention is characterized by a set of nesting containers, comprising an outer container and an inner container, each of the inner and outer containers having a substantially planar bottom portion and substantially upright surrounding sidewalls terminating in a rim, the inner container having a smaller outer diameter than an inner diameter of the outer container, a pair of handles connected to the surrounding sidewalls proximal to the rim thereof, each handle being on an opposite side of the rim and having a gripping portion with an upper surface and a lower surface on the opposite side of the upper surface in which the upper surface of the gripping portion has an adjacent outer and inner substantially planar horizontal portions and an at least a partially vertical transition portion between the outer and inner planar portions, the lower surface of the gripping portion having at least one substantially planar horizontal surface, wherein the handles of the inner container adapted so that the lower surface of the gripping portion can nestingly engage within the inner substantially planar horizontal portions of each gripping portion of the container handles so that when at least a portion of the lid engages the rim of the container the handles of the rim are supported by the gripping portion of the handles of the container.

A fourth aspect of the invention is accomplished by providing cookware vessel set comprising a container having a bottom surface and substantially upright surrounding sidewalls terminating in an upper rim, a lid adopted to cover at least an upper portion of the container within the upper rim thereof, the lid having an outer perimeter portion, each of the container and lid having a pair of handles disposed on opposite sides of the upper rim, wherein lid handles has a lower surface contour that nestingly engage in the complementary negative contour on an upper surface of the handles attached to the sidewall of the vessel.

The above and other objects, effects, features, and advantages of the present invention will become more apparent from the following description of the embodiments thereof taken in conjunction with the accompanying drawings.

### BRIEF DESCRIPTION OF DRAWINGS

FIG. 1 is a cross-section elevation view of a first embodiment of a combination cookware vessel and lid, showing the lid in the alternative positions on the vessel.

FIG. 2 is a cross-section elevation view of the stacking arrangement of a pair of vessels according to the embodiment of FIG. 1.

FIG. 3A-3D are various perspectives views of a particularly preferred embodiment of a handle according to the embodiment of FIGS. 1 and 2.

FIG. 4 is a cross-section elevation view of a preferred embodiment of a vessel and lid particularly adapted for stacking in a collection of kit.

FIG. 5 is a cross-section elevation view of a vessel and several lids particularly adapted for stacking in a collection of kit.

FIG. 6 is a cross-section elevation view of several vessel and lids in a tightly nested and staked arrangement.

FIG. 7 is a perspective view of the stacked arrangement shown in FIG. 6.

### DETAILED DESCRIPTION

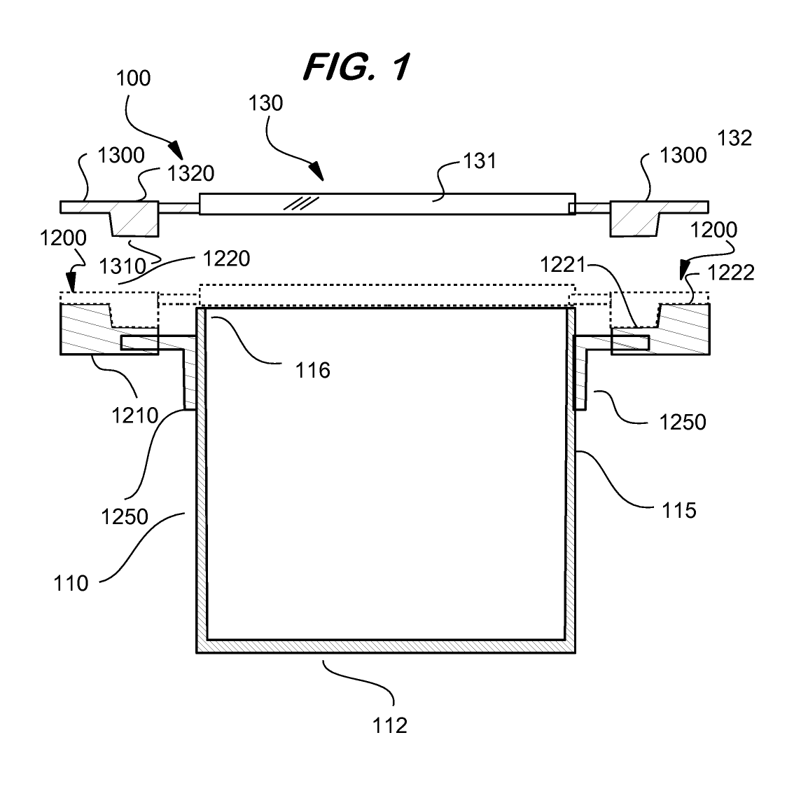

Referring to FIGS. 1 through 7, wherein like reference numerals refer to like components in the various views, there is illustrated therein a new and improved cookware article for deployment various embodiments of Nestable Cookware Assemblies, in which the combination of a vessel and a lid are generally denominated 100 herein.

In accordance with the present invention such cookware combinations 100 provide compact storage of cookware sets for the consumer, and include at least a first vessel 110 and a lid 130 that fits to the cover the inner portion thereof below rim 116. Such container while preferably metal, can also be porcelain coated steel or cast iron, ceramic, such as glass ceramic and the like. The vessel 110 is generally intended to be solid for containing fluid, that is having a bottom 112 with attached surrounding upright sides 115 that terminate at the rim 116.

Alternatively, and particularly in sets 600, at least one container vessel 110 is optionally perforated at one or more of the sides 115 and the bottom 112 to form a colander, strainer or steamer insert device for use in a larger diameter vessel.

Such vessel or container 110 has 2 handles 1200 disposed generally on opposite sides of the rim 116 and coupled directly or indirectly to the vessel sidewall 115. Each handle 1200 has a lower surface 1210 and an upper surface 1220. Upper surfaces 1220 are stepped, having inner portion 1221 and an outer portion 1222 that is generally higher than the inner portion 1221.

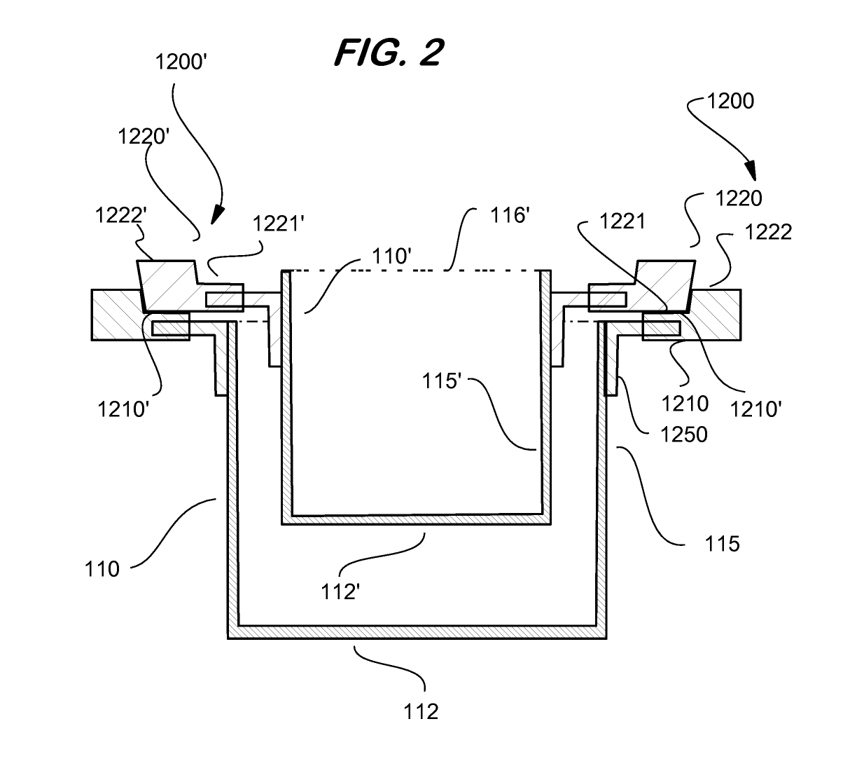

As shown in FIGS. 1 and 2 a nested lid 130 or nested container has a pair of handles 1300 with a similar but complimentary or inverted stepped profile on the bottom of the grip portion that is intended to engage the stepped profile on the upper surface 1220 or handle 1200. As shown first in FIG. 1, handles 1300 of the fitted component (lid or container) have an upper surface 1320 and lower surface 1310. The lower surface 1310 is configured to rest on and be supported by the inner portion 1221 of the upper surface 1220 of the handles 1200. Handles 1200 or 1300 may have one or more holes for hanging 1201 or 1301 respectively.

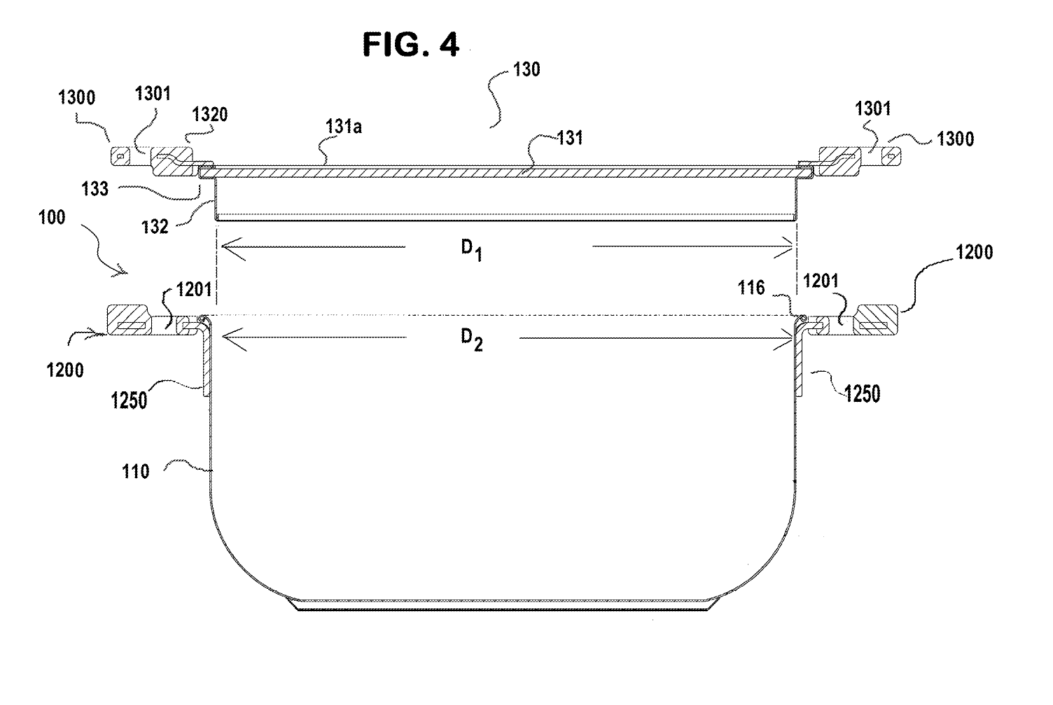

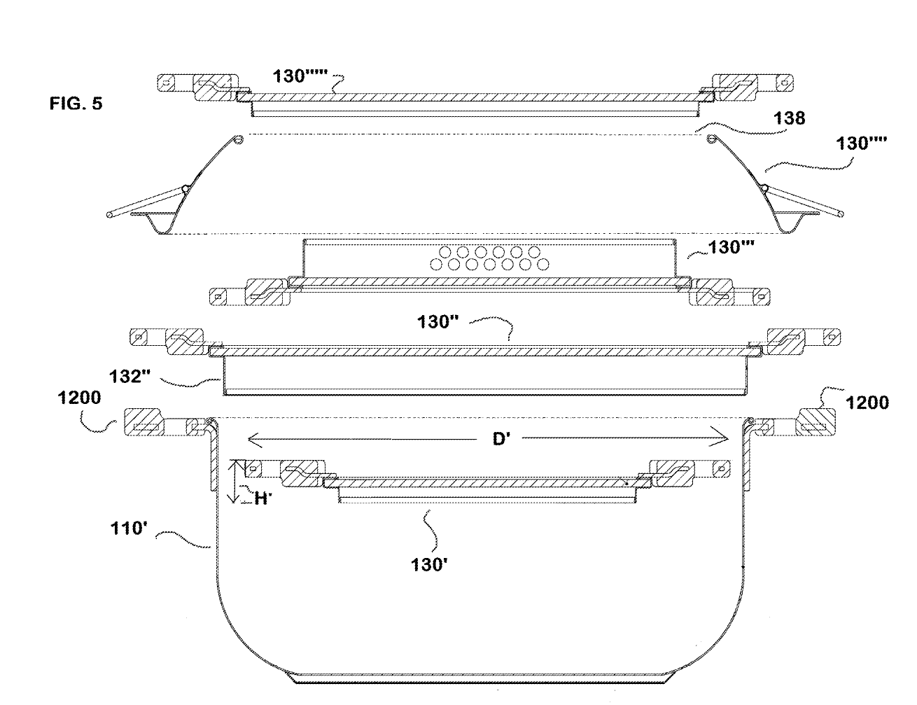

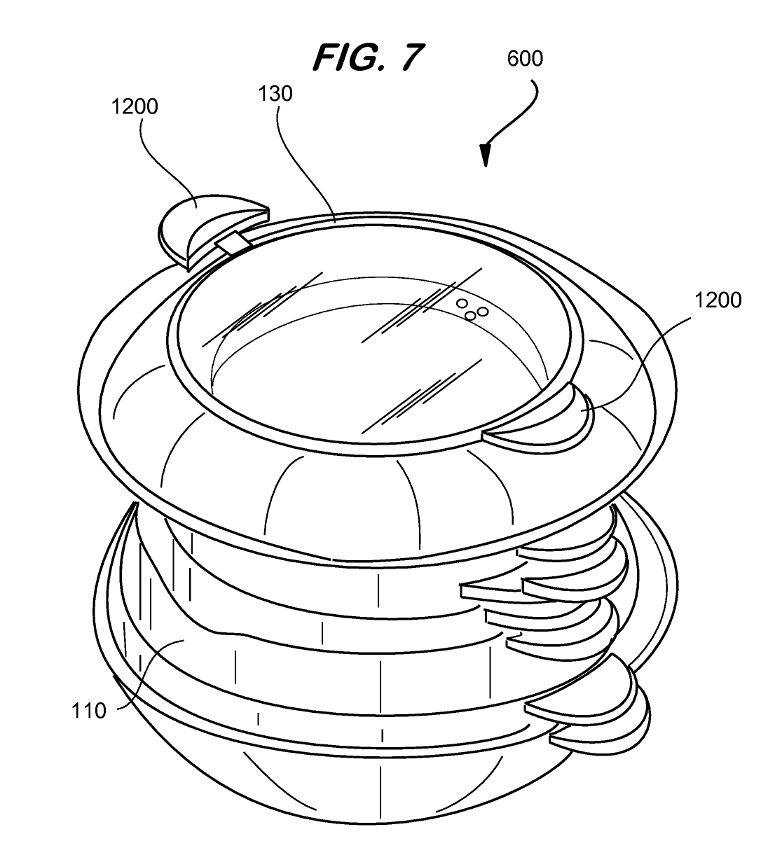

Likewise as shown in FIG. 2, a second vessel 110′ nests at least partially within the wider diameter, and generally taller outer vessel 110. The outer vessel 110 has handles 1200′. Handles 1200′ of the inner vessel or container 110′ have an upper surface 1220′ and lower surface 1210′. The lower surface 1210′ is configured to rest on and be supported by the inner portion 1221 of the upper surface 1220 of the handles 1200. More preferably, the side or outer vertical wall of the inner vessels handles 1200′ is complementary in shape to the lower step created by the surface 1221 and the transition to upper surface 1222 fitting therein in both the vertical and horizontal directions. Further when both sets of handles 1200 and 1300 have the same radial displacement with respect to the center of vessel 110, the user can lift and tilt the vessel 110 and lid 130 together by grabbing both handles 1200 and 1300, such as when the lid 130 has perforations to act as a strainer. Such a lid 130 is illustrated in FIG. 4, which also has a downward descending skirts 132 which may contain a plurality of holes, such as lid 130′″ in FIG. 5. When the vessel 110 also has a pouring spout at rim 116, this facilities the draining of water and fats away from cooked foodstuffs, such as pasta, vegetables and the like. As shown in FIG. 7, the third vessel from the bottom of the stack in kit 600 has such a spout formed at the rim thereof.

It is also preferable that lid 130 has a central upper covering portion 131 that is substantially planar. More preferably the lid's central portion 131 is glass, and most preferably tempered glass. It is also preferred that the top 131a of the central covering portion 131 of the lid 130 is below the upper surface 1320 of the attached handle 1320.

Lid 130 preferably also has a generally cylindrical downward extending skirt 132 disposed within its outer perimeter 133. The skirt 132 is configured to have an outer diameter D₁ that is slightly smaller than the inner diameter D₂ of the container below the rim thereof for sealing the inner container.

Cookware set 600 includes a plurality of planar lids of decreasing diameter each have a corresponding cylindrical downward extending skirt of decreasing height. This configuration is preferable as it enable some of the lids to completely nests within the cylindrical downward descending skirt of another lid such that the entire vertical height of the inner lid is less than or equal to the vertical height between the bottom of the skirt and the internal upper surface of the lid.

It should also be appreciated that for efficient stacking, the lower surface of each gripping portion of the handles (that is the portion extending laterally away from wall 115 and flange 1250) is preferably vertically disposed at the same height or level as the rim 116 of the container. Further, the flange portion of the inner container extends a further outward horizontal distance than the flange portion of the outer container. To the extent an inner container is intended to nest in a stack above the rim of an outer container, at least one of the vertical dimension of the flange or its connection with the gripping portion on the inner container can accommodate the intended vertical displacement of the inner vessel above the outer vessel.

As shown in FIG. 7, the profile of the transition between the upper and lower surface of the gripping portion within the horizontal plane is adapted to complementarily engage the outer perimeter profile of the grip on either the lid or an internally nested container.

Optionally, the handles of a connected container and lid (or inner container) can engage in a mating arrangement with the lower surface of the upper component handle (that is either the lid or the internal container) that nests within a hanging hole 1201 of lower component handle.

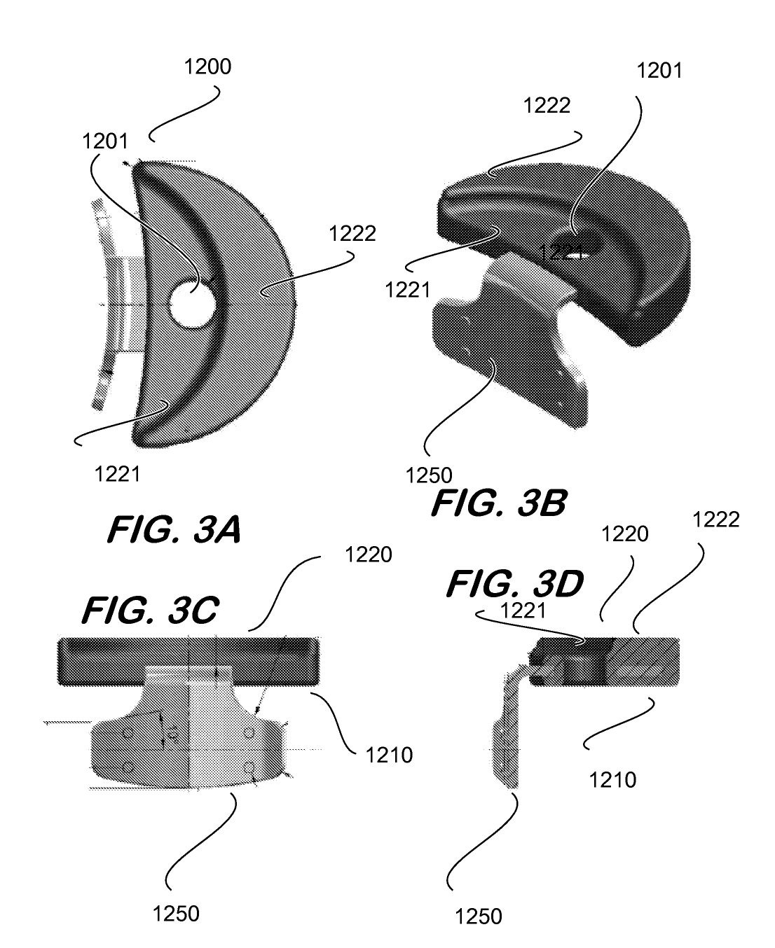

Further, the profile of the transition region within a plane that is at least parallel to the plane defined by the rim of the container is curvilinear, straight or combination of straight and curvilinear. The embodiment of FIG. 3A-D such a curved transition region. In addition, the profile of the transition region within a plane that is at transverse to the plane defined by the rim of the container is curvilinear, straight or combination of straight and curvilinear. The embodiment of FIGS. 1 and 2 shows a straight profile between surfaces 1221 and 1222, that is tilted slightly from vertical.

Further, while the stepped profile described above for the fitting lids and cookware vessel handles are a preferred embodiment, it should now be appreciated that another aspect of the invention is providing a cookware vessel and lid in which the lid has handles with a lower surface contour that nestingly engage in the complementary negative contour on the upper surface of the handles attached to the vessel wall below the rim thereof. Such profile is optionally configured to limit the rotation of the lid, but can have any shape in 2 or 3 dimensions.

A flange 1250 for each handle 1200 can be separate or integral to the handle construction, the term flange merely being that portion or component of the overall handle assembly that connects directly to the sidewall 115 of the cooking vessel 110. Ideally the flange and handle combination minimize heat transfer to the portion of the handle gripped by the user or cook.

In a set of containers 600, the set preferably includes at least 2 containers and at least one lid. Preferably, when the set or kit 600 contains 2 or more lids, at least one of the lids is nestable within the other lid so that the combined height of the lids is no higher than the outer lid.

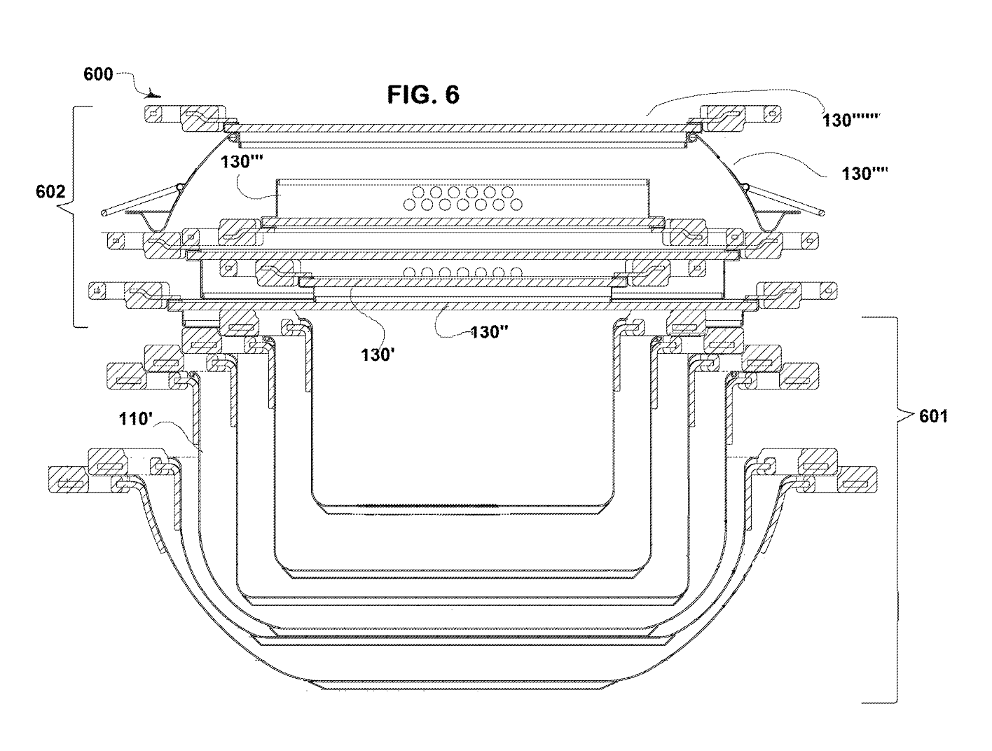

FIG. 5 illustrates a single vessel 110 with handles 1200 and a collection of lids 130′, 130″, 130′″, 130″″ and 130′″″ intended for nested stacking int eh collection of lids and vessels shown in FIG. 6. First, lid 130″ is the same lid that was illustrated in FIG. 4. Lid 130′ has a reduced skirt height H′ and diameter outer diameter D′ to nest within skirt 132″.

Likewise, although lids 130′″ and 130″″ are inverted, that is with the skirt pointing upward, lid 130′″ nests in lid 130′″. Lid 130″″ is the final cover for the aperture 138 in lid 130″″.

FIG. 6 illustrates a complete nested set or kit 600 in which at least a sub-set of vessels 601 including 110′ nests within each other without lids, and at least another subset of lids 602 separately nest in another portion of the set or kit 600. The sub-set of lids, being planar are readily stacked nested within each other.

In stack 600 in FIGS. 6 and 7, the upper lids 130′″″ and 130″″″ engage each other to form a dome shaped lid to fit the lowest and widest cooking vessel, which can option be a wok or saucier pan. However, the upper lid 130′″ also fits a smaller diameter vessel, that is the fourth largest that is immediately nested with vessel 110.

It should now be appreciated from the foregoing, that due to the stacked nesting shown in FIGS. 6 and 7, the handles 1200 and 1300 can be relatively wide, yet still accommodated with respect to not detrimentally increasing the height of the stack, or the width beyond the widest vessel rim and its handles. Accordingly, such wide handles are spaced sufficiently distal from the cookware rim to allow the user to conveniently handle and manipulate the cookware vessel 110.

The nested arrangement in the kit shown in FIGS. 6 and 7 is very stable, and the handles hold most of the vessel nested in the others. In particular, the external portions of smaller containers did not damage or more in the internal cooking surface of a larger container that it is intended to nest within. Thus, manufacturers and others in the distribution chain benefit from a reduction in packaging material and space required to store and ship the product.

Accordingly, the set or kit 600 is extremely versatile, combining different shape and volume vessel that can separately be selected as need to function as strainer as well as stock pots or a wok.

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

I claim:

1. A cookware vessel comprising:
a) a container having a bottom surface and substantially upright surrounding sidewalls terminating in an upper rim,
b) a pair of handles connected to the surrounding sidewalls proximal to the rim thereof, each handle being on an opposite side of the rim and having;
i) a gripping portion having; an upper surface and a lower surface on the opposite side of the upper surface, the upper surface of the gripping portion having adjacent outer and inner substantially planar horizontal portions and an at least partially vertical transition portion between the outer and inner planar portions, the lower surface of the gripping portion having at least one planar horizontal surface
c) a flange portion connected to the sidewalls of the cookware vessel, with the flange portion being connected to a gripping portion.

2. A covered cookware vessel comprising:
a) a container having a bottom surface and substantially upright surrounding sidewalls terminating in an upper rim,
b) a lid adopted to cover at least an upper portion of the container within the upper rim thereof, the lid having an outer perimeter portion,
c) each of the container and lid having a pair of handles, wherein;
i) the pair of handles of the container are coupled to the surrounding sidewalls proximal to the rim thereof, each handle being on an opposite side of the rim, and having a gripping portion with an upper surface and a lower surface on the opposite side of the upper surface, the upper surface of the gripping portion having adjacent outer and inner planar horizontal portions and an at least partially vertical transition portion between the outer and inner planar portions,
ii) the pair of handles of the lid are coupled to the outer perimeter portion thereof and having at least a lower surface comprising at least a substantially planar horizontal portion,
iii) wherein the substantially planar horizontal portions of the lid handles are adapted to nestingly engage within the inner planar horizontal portions of each gripping portion of the container handles so that when at least a portion of the lid engages the rim of the container the handles of the rim are supported by the gripping portion of the handles of the container.

3. The covered cookware vessel according to claim 2, wherein the lid has a central upper covering portion that is substantially planar.

4. The covered cookware vessel according to claim 3, wherein the central covering portion of the lid is glass.

5. A set of nesting containers, comprising:
a) an outer container and an inner container, each of the inner and outer containers having;
i) a substantially planar bottom portion and substantially upright surrounding sidewalls terminating in a rim, the inner container having a smaller outer diameter than an inner diameter of the outer container,
ii) a pair of handles connected to the surrounding sidewalls proximal to the rim thereof, each handle being on an opposite side of the rim and having a gripping portion with an upper surface and a lower surface on the opposite side of the upper surface in which the upper surface of the gripping portion has an adjacent outer and inner substantially planar horizontal portions and an at least a partially vertical transition portion between the outer and inner planar portions, the lower surface of the gripping portion having at least one substantially planar horizontal surface,
b) wherein the handles of the inner container adapted so that the lower surface of the gripping portion can nestingly engage within the inner substantially planar horizontal portions of each gripping portion of the container handles so that when at least a portion of the lid engages the rim of the container the handles of the rim are supported by the gripping portion of the handles of the container.

6. The set of nesting containers according to claim 5, wherein the set comprises one or more containers that includes a lid having a straining portion.

7. The set of nesting containers according to claim 6, wherein the lid of at least one vessel in the set has a generally cylindrical downward extending skirt disposed within an outer perimeter.

8. The set of nesting containers according to claim 7, wherein the skirt has an outer diameter that is smaller than an inner diameter of a container below the rim thereof for sealing the inner container.

9. The set of nesting containers according to claim 6, comprising a plurality of planar lids of decreasing diameter, each have a corresponding cylindrical downward extending skirt of decreasing height.

10. The set of nesting containers according to claim 7, wherein the skirt has a plurality of perforations.

11. The set of nesting containers according to claim 5, wherein the set comprises at least a sub-set of vessels which nest within each other without lids, and at least another subset of stacked of lids.

12. The set of nesting containers according to claim 5, wherein at least some of the lids in the set nests within the cylindrical downward skirt of another lid.

13. The set of nesting containers according to claim 5, wherein the gripping portion of each handle attached to a container is vertically disposed at substantially the same height as a rim of the container.

14. The set of nesting containers according to claim 5, and further comprising a dome shaped lid.

15. The set of nesting containers according to claim 14, wherein the dome shaped lid is formed of a first annular component that has an upper rim and a lower rim, the upper rim being narrower that the lower rim, and a second planar component that sealing fits within the upper rim.

16. The set of nesting containers according to claim 15, wherein the second planar components is operative to sealingly engage another container as the lid thereof.

17. The set of nesting containers according to claim 15 wherein at least one container of the set is a work or saucier pan.

18. The set of nesting containers according to claim 5, wherein the set comprises at least a first sub-set of containers which nest within each other without lids and a second subset of lids that nest within each other and are inverted with respect to the containers in the first sub-set.

19. The set of nesting containers according to claim 5, wherein at least one lid has a central upper covering portion that is substantially planar.

20. The set of nesting containers according to claim 5, wherein each lid has a central upper covering portion that is substantially planar.

21. The set of nesting containers according to claim 5, wherein the gripping portions of each container are attached to the sidewall thereof via a flange, wherein the flange portion of the inner container extends a further horizontal distance than the flange portion of the outer container.

22. The set of nesting containers according to claim 21, wherein the flange is coupled to the grip of the inner vessel to dispose the grip further below the rim of the inner vessel than the vertical displacement of the grip of the outer vessel below the rim of the inner vessel.

23. The set of nesting containers according to claim 22, where the flange of the inner vessel has a vertical height that is short than the flange of the outer vessel.

24. A cookware vessel set comprising:
a) a container having a bottom surface and substantially upright surrounding sidewalls terminating in an upper rim,
b) a lid adopted to cover at least an upper portion of the container within the upper rim thereof, the lid having an outer perimeter portion,
c) each of the container and lid having a pair of handles disposed on opposite sides of the upper rim, wherein lid handles has a lower surface contour that nestingly engage in the complementary negative contour on an upper surface of the handles attached to the sidewall of the vessel.
